(19) United States
(12) Patent Application Publication
(10) Pub. No.: US 2025/0317803 A1
(43) Pub. Date: Oct. 9, 2025

(54) SYSTEM AND METHOD FOR SPATIAL FREQUENCY REUSE IN WIRELESS COMMUNICATION

(71) Applicant: HUAWEI TECHNOLOGIES CO., LTD., Shenzhen (CN)

(72) Inventors: Hassan Aboubakr OMAR, Shenzhen (CN); Bo RAN, Shenzhen (CN); M Zulfiker ALI, Shenzhen (CN)

(21) Appl. No.: 19/243,201

(22) Filed: Jun. 19, 2025

Related U.S. Application Data
(63) Continuation of application No. PCT/CN2023/072577, filed on Jan. 17, 2023.

(51) Int. Cl. H04W 28/18; H04B 17/318; H04L 1/00; H04W 84/12

(52) U.S. Cl. CPC H04W 28/18; H04B 17/318; H04L 1/0003; H04L 1/0009; H04W 84/12

(57) ABSTRACT

The disclosed wireless communication systems and methods for i) determining that a protocol data unit (PDU) is ready for a transmission by a Wi-Fi apparatus; ii) determining a current environment state associated with the Wi-Fi apparatus; iii) based on the current environment state, selecting an action from a set of actions in accordance with a reinforcement learning (RL) technique configured to select the action suitable according to the current environment state; and iv) based on the selected action, transmitting the PDU.

### CROSS-REFERENCE TO RELATED APPLICATIONS

This application is a continuation of PCT Patent Application No. PCT/CN2023/072577, entitled “System and method for spatial frequency reuse in wireless communication”, filed Jan. 17, 2023, the entire contents of which are hereby incorporated by reference.

### TECHNICAL FIELD

The present disclosure generally relates to communication and, in particular, to a system, and a method for spatial frequency reuse in wireless communication.

### BACKGROUND

In recent years, a new Wi-Fi standard, referred to as the IEEE 802.11ax (or Wi-Fi 6) standard has been under development. An improvement in spatial frequency reuse is performed based on the IEEE 802.11ax standard, which allows a station (STA) to adjust a parameter, referred to as the overlapping basic service set (OBSS) packet detection (PD) level. The OBSS PD level adjustment provides an opportunity for the STA to simultaneously access the channel while receiving a frame from an OBSS STA member. The OBSS frame is received with a signal strength that is below the employed OBSS PD level. However, as defined in the IEEE 802.11ax standard, an increase of the OBSS PD level by a certain STA requires a decrease of the STA's transmit power level. This standard requirement creates a tradeoff between the channel contention time, required for an STA to get access of the channel, and the transmission duration, spent by an STA to completely transmit a frame after getting access of the channel.

In other words, by increasing the OBSS PD level, on one hand, the channel contention time is expected to decrease, allowing for a faster channel access, but on the other hand, a frame transmission duration may increase. As a result of an index of the employed modulation and coding scheme (MCS) is decreased.

With this said, there is an interest in developing system and method for spatial frequency reuse in wireless communication having a balanced tradeoff between the OBSS PD level and MCS index.

### SUMMARY

The embodiments of the present disclosure have been developed based on developers' appreciation of shortcomings associated with the prior arts. Conventionally, a Wi-Fi apparatus is configured to determine whether or not to use spatial re-use based on whether a signal is from an overlapping basic service set (OBSS) or basic service set (BSS). The Wi-Fi apparatus determines whether the detected frame is an inter-BSS or intra-BSS frame. If the detected frame is a inter BSS frame, under predetermined conditions, the Wi-Fi apparatus uses a predetermined OBSS packet detection (PD) level that is greater than the minimum receive sensitivity level to determine whether or not the Wi-Fi apparatus may perform an action such as spatially reuse the resource the frame is using.

Conventionally, in the IEEE 802.11ax (or Wi-Fi 6) the predetermined value of the OBSS PD level is set to −82 dBm., however, the IEEE 802.11ax standard may allow to update OBSS PD level. It is to be noted that in the IEEE 802.11ax, updating the OBSS PD level has to be jointly done between OBSS PD level and transmit power of the frame. In order to increase the OBSS PD level, the transmit power has to be reduced, thereby, reducing the channel contention time. It is contemplated that the reduction in channel contention time may result in an increase in the frame transmission duration, as a low modulation &coding scheme index is used to allow a destination STA to decode.

With this said, developers of the present technology have devised a system and a method for spatial frequency reuse in wireless communication having a balanced tradeoff between the OBSS PD level and the MCS index. Various embodiments of the present disclosure may rely on reinforcement learning (RL) to perform joint adjustment and find appropriate OBSS PD level and MCS index to increase the goodput of a STA by reducing a total time (i.e., the sum of contention time and transmission duration) required for successful delivery of a certain frame to its destination STA.

In accordance with a first broad aspect of the present disclosure, there is provided a wireless communication method comprising: determining that a protocol data unit (PDU) is ready for a transmission by a Wi-Fi apparatus; determining a current environment state associated with the Wi-Fi apparatus; based on the current environment state, selecting an action from a set of actions in accordance with a reinforcement learning (RL) technique configured to select the action suitable according to the current environment state; and based on the selected action, transmitting the PDU.

In accordance with any embodiments of the present disclosure, the method further comprises initializing parameters associated with the RL technique, wherein the parameters include one or more of a learning rate, a learning rate update parameter, a discount rate, an ∈-greedy parameter, a number of times the action has been attempted for the current environment state, an action value function, a threshold on a minimum number of times the action should be attempted for the current environment state before selecting a next action based on the current action value function.

In accordance with any embodiments of the present disclosure, the method further comprises determining that the action value function is required to be updated; in the event that action value function is to be updated and the discount rate is not equal to zero, updating the action value function based on a first criterion; and in the event that action value function is to be updated and the discount rate is equal to zero, updating the action value function based on a second criterion.

In accordance with any embodiments of the present disclosure, the first criterion is: retrieving a previous environment state, a previous action, and a previous reward associated with the previous action; and updating the action value function based on the current environment state, the previous environment state, the previous action, the previous reward, and the discount rate.

In accordance with any embodiments of the present disclosure, the second criterion is: retrieving a previous environment state, a previous action, and a previous reward associated with the previous action; and updating the action value function based on the previous environment state, the previous action, and the previous reward.

In accordance with any embodiments of the present disclosure, selecting the action from the set of actions comprises: generating a random number; and in the event that the random number is smaller than the ∈-greedy parameter, randomly selecting the action from the set of actions.

In accordance with any embodiments of the present disclosure, selecting the action from the set of actions comprises: generating a random number; and in the event that the random number is greater than the ∈-greedy parameter, and the number of times the action has been attempted for the current environment state is smaller than or equal to the threshold, selecting a predefined action.

In accordance with any embodiments of the present disclosure, selecting the action from the set of actions comprises: generating a random number; and in the event that the random number is greater than the ∈-greedy parameter, and the number of times the action has been attempted for the current environment state is greater than the threshold, selecting the action from the set of actions that maximizes the action value function.

In accordance with any embodiments of the present disclosure, the method further comprises calculating a reward corresponding to the selected action.

In accordance with any embodiments of the present disclosure, calculating the reward comprises: determining that an acknowledgment corresponding to the transmitted PDU is received from a second Wi-Fi apparatus; in the event that the acknowledgement is received, determining a delivery duration for delivering the PDU to the second Wi-Fi apparatus, and calculating the reward based on a length of the PDU and the delivery duration; in the event that the acknowledgement is not received, assigning a zero value to the reward.

In accordance with any embodiments of the present disclosure, the reward is calculated as a ratio of the length of the PDU and the delivery duration.

In accordance with any embodiments of the present disclosure, the current environment state includes one or more of: an identification of a second Wi-Fi apparatus, a length of the PDU, an average received signal strength indicator (RSSI) received by the Wi-Fi apparatus from the second Wi-Fi apparatus, an average RSSI received by the Wi-Fi apparatus from an unrelated Wi-Fi apparatus, a percentage of time when a channel is occupied by transmission from the other related Wi-Fi apparatuses, and a percentage of time when the channel is occupied by transmission from the other unrelated Wi-Fi apparatuses.

In accordance with any embodiments of the present disclosure, selecting the action includes selecting an index of modulation and coding scheme (MCS) and an overlapping basic service set (OBSS) packet detection (PD) level.

In accordance with a first broad aspect of the present disclosure, there is provided a wireless communication method comprising: a non-transitory memory element having instructions thereon; at least one processor coupled to the non-transitory memory element and execute the instructions to cause the wireless communication system to: determine that a protocol data unit (PDU) is ready for a transmission by a Wi-Fi apparatus; determine a current environment state associated with the Wi-Fi apparatus; based on the current environment state, select an action from a set of actions in accordance with a reinforcement learning (RL) technique configured to select the action suitable according to the current environment state; and based on the selected action, transmit the PDU.

In accordance with any embodiments of the present disclosure, the system further comprises initializing parameters associated with the RL technique, wherein the parameters include one or more of a learning rate, a learning rate update parameter, a discount rate, an ∈-greedy parameter, a number of times the action has been attempted for the current environment state, an action value function, a threshold on a minimum number of times the action should be attempted for the current environment state before selecting a next action based on the current action value function.

In accordance with any embodiments of the present disclosure, the wireless communication system is further configured to: determine that the action value function is required to be updated; in the event that action value function is to be updated and the discount rate is not equal to zero, update the action value function based on a first criterion; and in the event that action value function is to be updated and the discount rate is equal to zero, update the action value function based on a second criterion.

In accordance with any embodiments of the present disclosure, the wireless communication system is further configured to calculate a reward corresponding to the selected action.

### BRIEF DESCRIPTION OF THE FIGURES

Further features and advantages of the present disclosure will become apparent from the following detailed description, taken in combination with the appended drawings, in which:

FIG. 1 illustrates an environment of a wireless local area network (WLAN), in accordance with various embodiments of the present disclosure.

FIG. 2 illustrates a basic service set (BSS) and an overlapping basic service set (OBSS), in accordance with various non-limiting embodiments of the present disclosure.

FIG. 3 illustrates a framework associated with a reinforcement learning (RL), in accordance with various embodiments of the present disclosure.

FIG. 4 illustrates a high-level functional block diagram of an access point (AP), in accordance with various non-limiting embodiments of the present disclosure.

FIG. 5 depicts a process corresponding to a method for wireless communication, in accordance with various non-limiting embodiments of the present disclosure.

It is to be understood that throughout the appended drawings and corresponding descriptions, like features are identified by like reference characters. Furthermore, it is also to be understood that the drawings and ensuing descriptions are intended for illustrative purposes only and that such disclosures do not provide a limitation on the scope of the claims.

### DETAILED DESCRIPTION

The instant disclosure is directed to address at least some of the deficiencies of the current technology. In particular, the instant disclosure describes a system and a method for spatial frequency reuse in wireless communication.

Unless otherwise defined or indicated by context, all technical and scientific terms used herein have the same meaning as commonly understood by one of ordinary skill in the art to which the described embodiments appertain to.

In the context of the present specification, “Wi-Fi apparatus” is any computer hardware that is capable of running software appropriate to the relevant task at hand. In the context of the present specification, in general the term “Wi-Fi apparatus” is associated with a user of the Wi-Fi apparatus. Thus, some (non-limiting) examples of Wi-Fi apparatus include personal computers (desktops, laptops, netbooks, etc.), smartphones, and tablets, as well as network equipment such as routers, switches, modems and gateways. It should be noted that an apparatus acting as a Wi-Fi apparatus in the present context is not precluded from acting as an access point to other Wi-Fi apparatuses.

In the context of the present specification, unless provided expressly otherwise, the words “first”, “second”, “third”, etc. have been used as adjectives only for the purpose of allowing for distinction between the nouns that they modify from one another, and not for the purpose of describing any particular relationship between those nouns. Thus, for example, it should be understood that the use of the terms “first processor” and “third processor” is not intended to imply any particular order, type, chronology, hierarchy or ranking (for example) of/between the server, nor is their use (by itself) intended to imply that any “second processor” must necessarily exist in any given situation. Further, as is discussed herein in other contexts, reference to a “first” element and a “second” element does not preclude the two elements from being the same actual real-world element. Thus, for example, in some instances, a “first” server and a “second” server may be the same software and/or hardware, in other cases they may be different software and/or hardware.

It will be understood that when an element is referred to as being “connected” or “coupled” to another element, it can be directly or indirectly connected or coupled to the other element or intervening elements that may be present. In contrast, when an element is referred to as being “directly connected” or “directly coupled” to another element, there are no intervening elements present. Other words used to describe the relationship between elements should be interpreted in a like fashion (e.g., “between” versus “directly between,” “adjacent” versus “directly adjacent,” etc.).

In the context of the present specification, when an element is referred to as being “associated with” another element, in certain embodiments, the two elements can be directly or indirectly linked, related, connected, coupled, the second element employs the first element, or the like without limiting the scope of present disclosure.

The terminology used herein is only intended to describe particular representative embodiments and is not intended to be limiting of the present technology. As used herein, the singular forms “a,” “an” and “the” are intended to include the plural forms as well, unless the context clearly indicates otherwise. It will be further understood that the terms “comprises” and/or “comprising”, when used in this specification, specify the presence of stated features, integers, steps, operations, elements, and/or components, but do not preclude the presence or addition of one or more other features, integers, steps, operations, elements, components, and/or groups thereof.

Implementations of the present technology each have at least one of the above-mentioned objects and/or aspects, but do not necessarily have all of them. It should be understood that some aspects of the present technology that have resulted from attempting to attain the above-mentioned object may not satisfy this object and/or may satisfy other objects not specifically recited herein.

The examples and conditional language recited herein are principally intended to aid the reader in understanding the principles of the present technology and not to limit its scope to such specifically recited examples and conditions. It will be appreciated that those skilled in the art may devise various arrangements which, although not explicitly described or shown herein, nonetheless embody the principles of the present technology and are included within its spirit and scope.

Furthermore, as an aid to understanding, the following description may describe relatively simplified implementations of the present technology. As persons skilled in the art would understand, various implementations of the present technology may be of a greater complexity.

In some cases, what are believed to be helpful examples of modifications to the present technology may also be set forth. This is done merely as an aid to understanding, and, again, not to define the scope or set forth the bounds of the present technology. These modifications are not an exhaustive list, and a person skilled in the art may make other modifications while nonetheless remaining within the scope of the present technology. Further, where no examples of modifications have been set forth, it should not be interpreted that no modifications are possible and/or that what is described is the sole manner of implementing that element of the present technology.

Moreover, all statements herein reciting principles, aspects, and implementations of the present technology, as well as specific examples thereof, are intended to encompass both structural and functional equivalents thereof, whether they are currently known or developed in the future. Thus, for example, it will be appreciated by those skilled in the art that any block diagrams herein represent conceptual views of illustrative circuitry embodying the principles of the present technology. Similarly, it will be appreciated that any flowcharts, flow diagrams, state transition diagrams, pseudo-code, and the like represent various processes which may be substantially represented in computer-readable media and so executed by a computer or processor, whether or not such computer or processor is explicitly shown.

The functions of the various elements shown in the figures, including any functional block labeled as a “processor” or a “processing unit”, may be provided through the use of dedicated hardware as well as hardware capable of executing software in association with appropriate software. When provided by a processor, the functions may be provided by a single dedicated processor, by a single shared processor, or by a plurality of individual processors, some of which may be shared. In some embodiments of the present technology, the processor may be a general-purpose processor, such as a central processing unit (CPU) or a processor dedicated to a specific purpose, such as a graphics processing unit (GPU). Moreover, explicit use of the term “processor” or “controller” should not be construed to refer exclusively to hardware capable of executing software, and may implicitly include, without limitation, digital signal processor (DSP) hardware, network processor, application specific integrated circuit (ASIC), field programmable gate array (FPGA), read-only memory (ROM) for storing software, random access memory (RAM), and non-volatile storage. Other hardware, conventional and/or custom, may also be included.

In the context of the present disclosure, the expression “data” includes data of any nature or kind whatsoever capable of being stored in a database. Thus, data includes, but is not limited to, audiovisual works (images, movies, sound records, presentations etc.), data (location data, numerical data, etc.), text (opinions, comments, questions, messages, etc.), documents, spreadsheets, etc.

Software modules, modules, or units which are implied to be software, may be represented herein as any combination of flowchart elements or other elements indicating performance of process steps and/or textual description. Such modules may be executed by hardware that is expressly or implicitly shown.

With these fundamentals in place, the instant disclosure is directed to address at least some of the deficiencies of the current technology. In particular, the instant disclosure describes a system and a method for spatial frequency reuse in wireless communication.

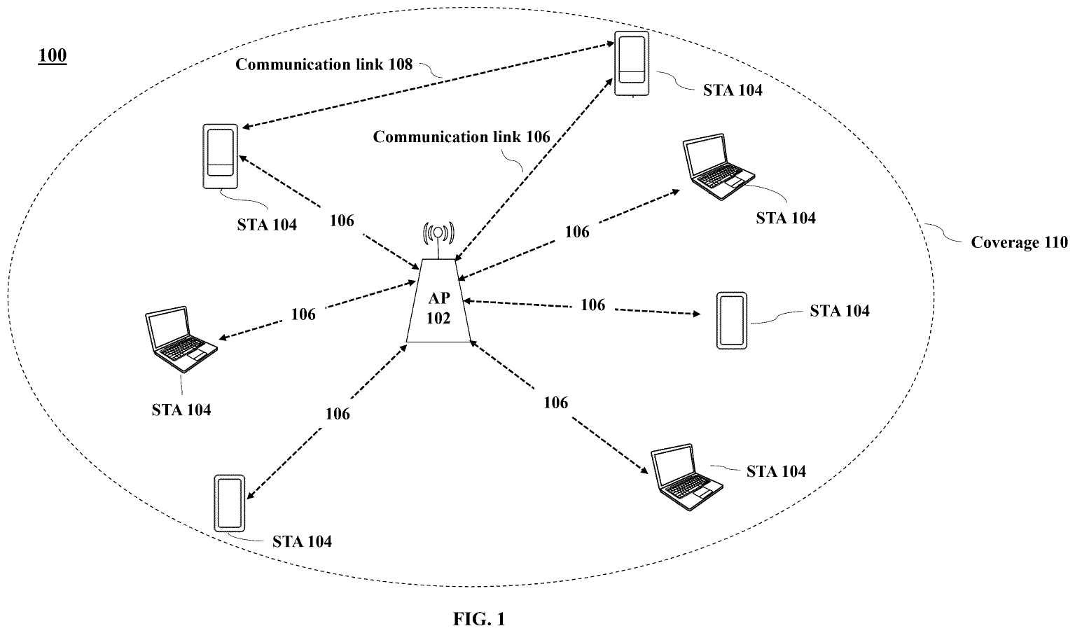

FIG. 1 illustrates an environment of a wireless local area network (WLAN) 100, in accordance with various embodiments of the present disclosure. The WLAN 100 may include several wireless devices such as an access point (AP) 102 and multiple associated stations (STAs) 104. Each of the STAs 104 may also be referred to as a mobile station (MS), a mobile device, a mobile handset, a wireless handset, an access terminal (AT), a user equipment (UE), a subscriber station (SS), or a subscriber unit, among other possibilities. The STAs 104 may represent various devices such as mobile phones, personal digital assistant (PDAs), other handheld devices, netbooks, notebook computers, tablet computers, laptops, display devices (for example, TVs, computer monitors, navigation systems, among others), printers or the like. In other words, the STAs 104 may be any electronic device capable of wirelessly communicating with other electronic devices and/or AP 102. In certain non-limiting embodiments, the WLAN 100 may be a network implementing at least one of the IEEE 802.11 family of standards.

In certain non-limiting embodiments, each of the STAs 104 may associate and communicate with the AP 102 via a communication link 106. The various STAs 104 in the network are able to communicate with one another through the AP 102. A single AP 102 and an associated set of STAs 104 may be referred to as a basic service set (BSS). FIG. 1 additionally shows an example coverage area 110 of the AP 102, which may represent a basic service area (BSA) of the WLAN 100. While only one AP 102 is shown, the WLAN 100 may include multiple APs 102. An extended service set (ESS) may include a set of connected BSSs. An extended network station associated with the WLAN 100 may be connected to a wired or wireless distribution system that may allow multiple APs 102 to be connected in such an ESS. As such, a STA 104 may be covered by more than one AP 102 and may associate with different APs 102 at different times for different transmissions.

In certain non-limiting embodiments, the STAs 104 may function and communicate (via the respective communication links 106) according to the IEEE 802.11 family of standards and amendments including, but not limited to, 802.11a, 802.11b, 802.11g, 802.11n, 802.11ac, 802.11ad, 802.11ah, 802.11af, 802.11ay, 802.11ax, 802.11az, 802.11ba, and 802.11be. These standards define the WLAN radio and baseband protocols for the PHY and medium access control (MAC) layers. The STAs 104 in the WLAN 100 may communicate over an unlicensed spectrum, which may be a portion of the spectrum that includes frequency bands traditionally used by Wi-Fi technology, such as the 2.4 GHz band, and the 5 GHz band. The unlicensed spectrum may also include other frequency bands, such as the emerging 6 GHz band. The STAs 104 in the WLAN 100 may also be configured to communicate over other frequency bands such as shared licensed frequency bands, where multiple operators may have a license to operate in the same or overlapping frequency band or bands.

In certain non-limiting embodiments, the STAs 104 may form networks without APs 102 or other equipment other than the STAs 104 themselves. One example of such a network is an ad hoc network (or wireless ad hoc network). Ad hoc networks may alternatively be referred to as mesh networks or peer-to-peer (P2P) connections. In some cases, ad hoc networks may be implemented within a larger wireless network such as the WLAN 100. In such implementations, while the STAs 104 may be capable of communicating with each other through the AP 102 using communication links 106, STAs 104 also may communicate directly with each other via direct wireless communication links 108. Additionally, two STAs 104 may communicate via a direct wireless communication link 108 regardless of whether both STAs 104 are associated with and served by the same AP 102. In such an ad hoc system, one or more of the STAs 104 may assume the role filled by the AP 102 in a BSS. Such a STA 104 may be referred to as a group owner (GO) and may coordinate transmissions within the ad hoc network. Examples of direct wireless communication links 108 include Wi-Fi Direct connections, connections established by using a Wi-Fi Tunneled Direct Link Setup (TDLS) link, and other peer-to-peer (P2P) group connections.

In certain non-limiting embodiments, some types of STAs 104 may provide for automated communication. Automated wireless devices may include those implementing internet-of-things (IoT) communication, Machine-to-Machine (M2M) communication, or machine type communication (MTC). The IoT, M2M or MTC may refer to data communication technologies that allow devices to communicate without human intervention. For example, IoT, M2M or MTC may refer to communications from STAs 104 that integrate sensors or meters to measure or capture information and relay that information to a central server or application program that may make use of the information or present the information to humans interacting with the program or application.

In certain non-limiting embodiments, WLAN 100 may support beamformed transmissions. As an example, AP 102 may use multiple antennas or antenna arrays to conduct beamforming operations for directional communications with a STA 104. Beamforming (which may also be referred to as spatial filtering or directional transmission) is a signal processing technique that may be used at a transmitter (e.g., AP 102) to shape and/or steer an overall antenna beam in the direction of a target receiver (e.g., a STA 104).

In certain non-limiting embodiments, WLAN 100 may further support multiple-input, multiple-output (MIMO) wireless systems. Such systems may use a transmission scheme between a transmitter (e.g., AP 102) and a receiver (e.g., a STA 104), where both transmitter and receiver are equipped with multiple antennas. For example, AP 102 may have an antenna array with a number of rows and columns of antenna ports that the AP 102 may use for beamforming in its communication with a STA 104. Signals may be transmitted multiple times in different directions (e.g., each transmission may be beamformed differently). The receiver (e.g., STA 104) may try multiple beams (e.g., antenna subarrays) while receiving the signals.

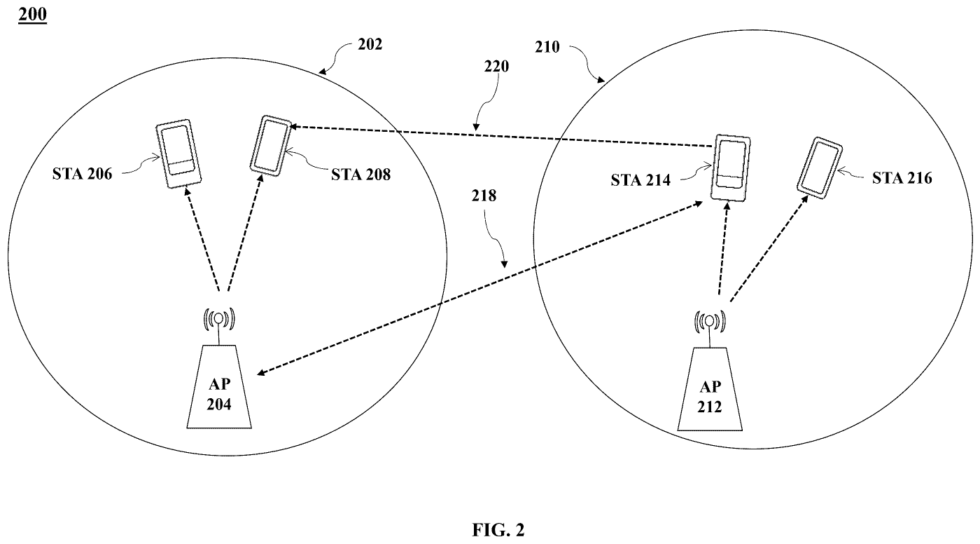

FIG. 2 illustrates a BSS 202 and an overlapping basic service set (OBSS) 210 in accordance with various non-limiting embodiments of the present disclosure. As shown, the BSS 202 may include AP 204 and STAs 206, and 208. The OBSS 210 may AP 212 and STAs 214, and 216. Further, it is contemplated that the APs 204 and 212 may be implemented in a similar manner to the AP 102 and the STAs 206, 208, 214 and 216 may be implemented in a similar manner to the STA 104 as previously discussed in FIG. 1.

In certain embodiments, the STAs 206, 208, 214, and 216 and/or the APs 204 and 212 may be configured to determine whether or not to use spatial re-use based on whether a signal 206 is from an OBSS 210 or BSS 202. By way of example, the STAs 206, and 208 may determine whether the detected frame is an inter-BSS or intra-BSS frame by using BSS color, which may be indicated in a physical header (e.g., SIG-A) or MAC address in the MAC header. If the detected frame is a inter BSS frame, under predetermined conditions, the STAs 206, and 208 may use a predetermined an OBSS packet detection (PD) level associated with the OBSS 210 that is greater than the minimum receive sensitivity level to determine whether or not the STAs 206, and 208 may perform an action such as spatially reuse the resource the frame is using.

For example, the STA 208 may receive a signal 220 and if an OBSS PD level of the signal 220 is below a predetermined OBSS PD level for OBSS 210, then the STA 208 may transmit a frame that overlaps the time at which the signal 220 is transmitted and may use the same or an overlapping sub-channel as that of the signal 220. On the other hand, if the OBSS PD level of the signal 220 is above the predetermined OBSS PD level for OBSS 210, then the STA 208 may not transmit a frame that overlaps the time at which the signal 220 is transmitted and may use the same or an overlapping sub-channel as that of the signal 220.

Conventionally, in the IEEE 802.11ax (or Wi-Fi 6) the predetermined value of the OBSS PD level is set to −82 dBm, however, the IEEE 802.1ax standard may allow to update OBSS PD level. It is to be noted that in the IEEE 802.11ax, updating the OBSS PD level has to be jointly done between OBSS PD level and transmit power of the frame. In order to increase the OBSS PD level, the transmit power has to be reduced, thereby, reducing the channel contention time. It is contemplated that the reduction in channel contention time may result in an increase in the frame transmission time, as a low index modulation & coding scheme is used to allow a destination STA to decode.

With this said, there is an interest in developing a system and a method for spatial frequency reuse in wireless communication having a balanced tradeoff between the OBSS PD level and an index of the MCS. Various embodiments of the present disclosure may rely on reinforcement learning (RL) to perform joint adjustment and find appropriate OBSS PD level and the index of the MCS to increase the goodput of a STA by reducing a total time (i.e., the sum of contention time and transmission duration) required for successful delivery of a certain frame to its destination STA.

The RL may assist the APs, and/or the STAs in reducing a difficulty in deriving a mathematical model incorporating the dominating factors that may affect an OBSS PD level selection. Further, the RL may have high potential of learning a Wi-Fi network environment. By way of example, in a home WiFi deployment, since: i) the locations of various interfering Wi-Fi sources rarely change, e.g., access points (APs), TVs, and desktops in neighboring apartments, and ii) the behavior of people at home does not change significantly over time, e.g., the location where a person is used to stay when making a video call, the places where a person usually leaves his/her cell phone, the time of the day when a person accesses social media websites or watches online videos, etc.

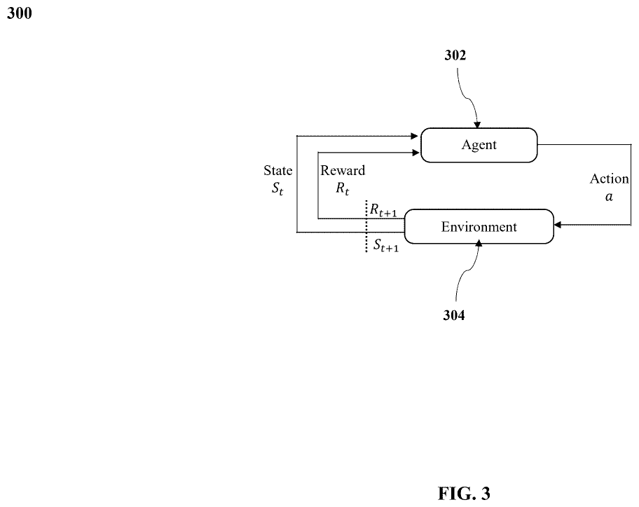

FIG. 3 illustrates a framework 300 associated with the RL, in accordance with various embodiments of the present disclosure. As shown, the framework 300 may include an agent 302, and an environment 304. The agent 302 may interact with certain environment conditions. Based on a current state Sₜ and a previous reward Rₜ of the environment 304 at a given time instant, the agent 302 may take an action a.

Based on this action a, the environment 304 moves to a next state Sₜ₊₁ and the agent 302 may obtain a reward Rₜ₊₁, based on the results of the action a taken at time t, and so on. Based on the environment state, the agent 302 may select the action a is to be taken by employing a given policy. In so doing, the agent 302 may learn to improve the policy that reduces an expected value of a return at each environment state, where the return may be defined as any function of the reward sequence Rₜ.

The framework 300 may formulate an environment state representation, an action set definition, reward sequence and return function design, and a learning method description. The environment state representation is for consideration of the dominating factors that affect spatial frequency in a WLAN 100. The action set definition is for joint OBSS PD level selection and MCS adaptation by the agent 302 for transmission of each frame. The reward sequence and return function design is for increasing of the goodput achieved by a STN employing the framework 300. The learning method description is for learning a policy that increases the goodput, while avoiding unexpected spatial reuse technique.

The environment state may provide a suitable basis for the agent 302 to select suitable actions. Consequently, the environment state may be defined to incorporate the dominating factors that may be considered for OBSS PD level adjustment and MCS adaptation by a STA (for example, STA 208), including: i) the destination STA (for example, STA 206) of the frame that STA 208 may be attempting to deliver, ii) the size of the frame that STA 208 may be attempting to deliver, iii) the received signal strength indicator (RSSI) of frames received by STA 208 from the destination STA 206, iv) the RSSI of OBSS frames received by STA 208, v) the percentage of time the channel is occupied by the transmission of a frame from the BSS 202 associated with the STA 208, and vi) the percentage of time the channel is occupied by an OBSS frame transmission.

In certain non-limiting embodiments, a set of environment states, [symbol] , may be defined as follows:

$$= \{ ( n , f , d , i , b , o ) : n ∈ , f ∈ , d ∈ , i ∈ , b ∈ , and o ∈ \} \qquad ( 1 )$$

In the set of environment states, [symbol] , n may be an ID of the destination STA 206 selected from a set of IDs of destination STAs [symbol] . The frame length f may be selected from a discrete set of frame lengths (in Kbytes) [symbol] . The average RSSI d may be received by STA 208 from STA 206 and calculated over a specified number of frames that are most recently received by STA 208 from STA 206. The average RSSI d may belong to a discrete set of RSSI values (in dBm) [symbol] . The average RSSI i may be received by STA 208 from OBSSs (for example, OBSS 210) and calculated over a specified number of OBSS frames that are most recently received by STA 208. The average RSSI i may belong to a discrete set of RSSI values (in dBm) [symbol] . The percentage of time b may be the time when the channel is occupied by the transmission of a frame from the other STAs associated with the BSS 202, calculated using sliding window averaging, with a specified window size. The percentage of time b may belong to a discrete set of percentages [symbol] . The percentage of time o may be the time when the channel is occupied by the transmission of an OBSS frame, calculated using sliding window averaging, with a specified window size. The percentage of time o may belong to a discrete set of percentages [symbol] .

A given element of the environment state may be represented as s(j) that belongs to the j^{th} element of a state s∈ [symbol] ,∀ j=1, . . . , 6. By way of example, for [symbol] ={1, 16, 32, 64, 128}, [symbol] ={−80, −70, −60, −50, 0}, [symbol] ={−80, −75, −70, −65, 0}, and [symbol] ={25, 50, 75, 100}, an environment state can have the following value:

$$s = ( 1 , 32 , 0 , - 75 , 50 , 25 ) \qquad ( 2 )$$

In the above environment state, the STA 208 is intended to send a frame to the STA having ID 1 (for example, STA 206), a frame length is between 16 Kbytes and 32 Kbytes, an average RSSI received by the STA 208 from the STA 206 is above −50 dBm, an average RSSI received by STA 208 from surrounding OBSSs (for example, OBSS 210) is between −75 dBm and −80 dBm, a percentage of time the channel is occupied by the transmission of a frame from the other STAs associated with the BSS 202 is between 25% and 50%, and a percentage of time the channel is used for OBSS frame transmission is 25%.

Further, a set of action associated with the state s may be denoted as [symbol] ₛ, where:

$${s}_{} = \{ ( m , l ) : m ∈ {s}_{} , l ∈ ℒ \} , ∀ s ∈ \qquad ( 3 )$$

Based on the current environment state, the agent 302 may select an index m of the MCS and an OBSS PD level l that may be used by the STA 208. The index m may belong to a set of MCS indices that may be used by STA 208 for frame transmission to STA 206 e.g., BPSK, 64 QAM, 1024 QAM or the like. The OBSS PD level l may belong to a set of OBSS PD level that may be used by STA 208, e.g., {−82, −81, . . . , −73}.

As previously discussed, the agents 302 may work towards increasing the expected return, which may be a function of the reward sequence Rₜ, the reward and return may be defined such that together they increase a goodput of the STA 208. Hence, at time step t−1, if the environment is at state s∈ [symbol] and the agent 302 takes an action a=(m, l)∈ [symbol] ₛ, the reward and return at time step t, respectively denoted by Rₜ and Gₜ, The reward Rₜ may be defined as follows:

$${R}_{t} = \{ \begin{matrix}\frac{s ( 2 )}{{T}_{t - 1}} \\ 0 ,\end{matrix} \qquad ( 4 )$$

In case, the frame is successfully delivered to STA s(1), i.e., if an acknowledgment (ACK) frame is received by STA 208 from the STA 206, the reward Rₜ may be equal to

$$\frac{s ( 2 )}{{T}_{t - 1}} , \qquad ( 2 )$$

where s(2) may be the length of the frame, and Tₜ₋₁ may be the total delivery duration of the frame transmitted at time step t−1, i.e., the sum of the channel contention time, inter-frame spacing duration, and PPDU/ACK transmission duration, which depend on the selected MCS index, m. In case, the frame is not delivered to STA 206, i.e., if an ACK timeout occurs, the reward Rₜ may be equal to 0. It is clear from the above discussion that if a larger frame is transmitted in a smaller time duration, the reward is higher. The agent 302 may learn that a given action a in a given environment state s increases or decreases the reward.

The reward Gₜ may be defined as follows:

$${G}_{t} = {\sum }_{k = 0}^{∞} {γ}^{k} {R}_{t + k + 1} \qquad ( 5 )$$

The term γ may represent a discount rate such that γ∈[0,1], which determines the present value of future rewards. For γ equals to one may refer to as same weight has been given to all future rewards. Also, for γ equals to zero, may be referred to as weight for all future rewards is going to be zero except for the next reward.

Further, the learning method may be referred to as an algorithm employed by agent 302 to learn an effective policy. In certain non-limiting embodiments, a Q-learning method may be employed in the agent 302, which may aim at iteratively learning the effective action-value function, q_{*}(s, a)∀s∈ [symbol] , a∈ [symbol] ₛ. Once the Q-learning method converges to the effective action-value function, the effective policy may be directly obtained by selecting the action that increases q_{*}(s, a) at a certain state s∈ [symbol] .

In certain non-limiting embodiments, the agent 302 may arbitrarily initialize the action value function, q₀(s, a), ∀s∈ [symbol] , a∈ [symbol] ₛ. The agent 302 may determine an initial state s. The agent 302 may repeat for each time step t: i) choose an action, a, from [symbol] ₛ using a certain behavior policy (for example, ∈-greedy parameter), ii) take action a and observe the reward Rₜ, and the next state s′, and iii) update the q function and the current state using:

$${q}_{t + 1} ( s , a ) ← {q}_{t} ( s , a ) + {α}_{s , a , t} [ {R}_{t + 1} + γ {max}_{a} {q}_{t} ( {s}^{′} , a ) - {q}_{t} ( s , a ) ] \qquad ( 6 )$$

$$s ← {s}^{′} \qquad ( 7 )$$

The term qₜ₊₁(s, a) may be referred to as the action value function at the start of time step t+1. The term α_{s,a,t} may be referred to as the learning rate, which may be varied based on the time step index, state, and action. The ϵ-greedy parameter, may be a policy that may select a suitable action (based on the current action-value function) with a probability 1-ϵ, and may select an action equally likely among all the available actions with a probability ϵ.

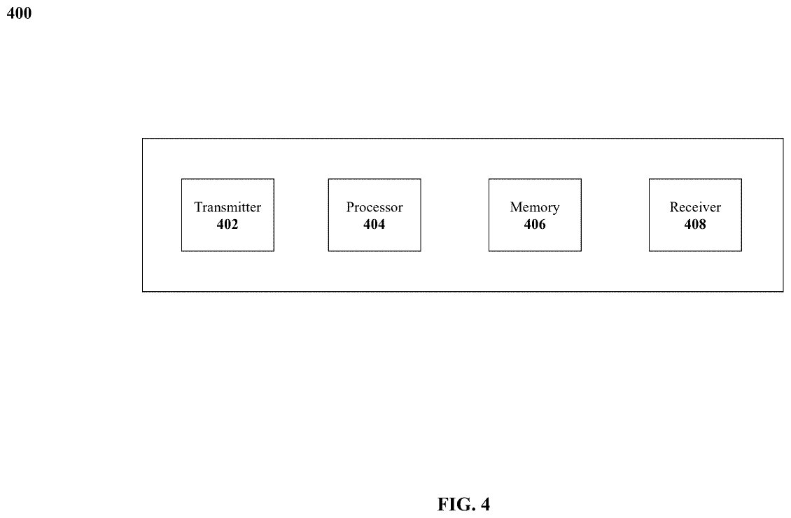

FIG. 4 illustrates a high-level functional block diagram of a Wi-Fi apparatus 400, in accordance with various non-limiting embodiments of the present disclosure. As shown, the Wi-Fi apparatus 400 may include a transmitter 402, a processor 404, a memory 406 and a receiver 408. It is to be noted that the AP 400 may include other components, however, such components have been omitted from FIG. 4 for the purpose of simplicity.

In certain non-limiting embodiments, the transmitter 402 and the receiver 408 may communicate with other APs and STAs in the WLAN 100 over the communication link 106. Further, the memory 406 including a non-transitory portion may store instructions to be implemented by the processor 404 to implement various non-limiting embodiments of the present disclosure. Also, the transmitter 402, the processor 404, the memory 406 and the receiver 408 may be communicably connected with each other. Also, various APs and STAs discussed in the present disclosure may be implemented in a similar manner as that of the Wi-Fi apparatus 400.

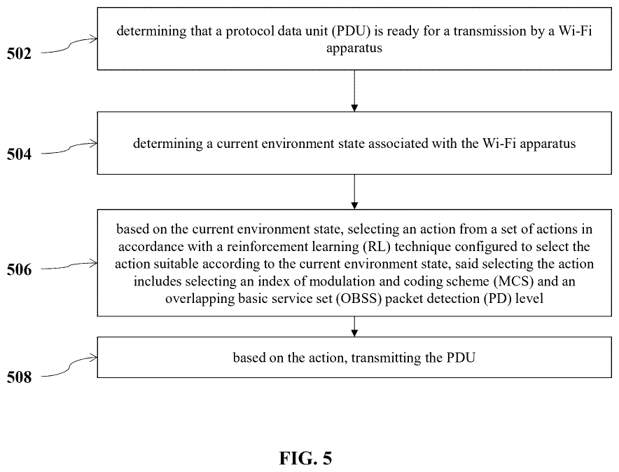

FIG. 5 depicts a process 500 corresponding to a method for wireless communication, in accordance with various non-limiting embodiments of the present disclosure. As shown, the process 500 commences at step 502 where a Wi-Fi apparatus (for example AP 204 and/or STA 208) determines that a protocol data unit (PDU) is ready for the transmission. In the event that the PDU is not ready for transmission, the Wi-Fi apparatus may wait until the PDU is ready for transmission. In the event that the PDU is ready for transmission, the process 500 advances to step 504.

At step 504, the Wi-Fi apparatus may determine an associated current environment state s. Without limiting the scope of present disclosure and as previously discussed, the current environment state s may include one or more of: an identification of a second Wi-Fi apparatus (for example, STA 206), a length of the PDU, an average RSSI received by the Wi-Fi apparatus from the second Wi-Fi apparatus, an average RSSI received by the Wi-Fi apparatus from an unrelated Wi-Fi apparatus (for example, AP 202), a percentage of time when a channel is occupied by transmission from the other related Wi-Fi apparatuses, and a percentage of time when the channel is occupied by transmission from the other unrelated Wi-Fi apparatuses.

The process 500 advances to step 506, where based on the current environment state s, the Wi-Fi apparatus may select the action a from the set of actions [symbol] ₛ in accordance with the RL technique configured to select the action suitable according to the current environment state s. Selection of the action a from the set of actions [symbol] ₛ may include selecting an index of modulation and coding scheme (MCS) and an overlapping basic service set (OBSS) packet detection (PD) level. It is to be noted that prior to performing various steps, in certain non-limiting embodiments, the Wi-Fi apparatus may be configured to initialize various parameters associated with the RL technique. By way of example, the Wi-Fi apparatus may initialize one or more of a learning rate α_{s,a}, a learning rate update parameter p_{s,a}, the discount rate γ, the ϵ-greedy parameter, a number n_{s,a} representing a number of times the action has been attempted for the current environment state s, a threshold η on number of times the action should be attempted for the current environment state s, and an action value function q(s, a).

In one example, the initial value of the learning rate α_{s,a} may be equal to 0, the initial value of the learning rate update parameter p_{s,a} may be equal to 1, the discount rate γ, may be initialized to a zero or a non-zero value, the ϵ-greedy parameter may be equal to 0.01, the initial value of the number n_{s,a} may be equal to 0, the threshold η may be equal to 5, and the initial value of the action value function q(s, a) may be equal to 0.

In certain embodiments, Wi-Fi apparatus may be configured to determine if the action value function q(s, a) is required to be updated. In the event that the action value function q(s, a) is to be updated and the discount rate γ is not equal to zero, the Wi-Fi apparatus may update the action value function q(s, a) based on a first criterion. The first criterion may be retrieving a previous environment state, a previous action, and a previous reward associated with the previous action. The Wi-Fi apparatus may update the action value function q(s, a) based on the previous environment state s′, the previous action a_{*}, the previous reward R, and the discount rate γ as follows:

$$q ( s , a ) ← q ( s , a ) + {α}_{s , a} [ R + γ {max}_{a} q ( {s}^{′} , {a}_{*} ) - q ( s , a ) ] \qquad ( 8 )$$

In the event that the discount rate γ is equal to zero, the Wi-Fi apparatus may update the action value function q(s, a) based on a second criterion. The second criterion may be updating the action value function q(s, a) based on the previous environment state s′, the previous action a_{*}, and the previous reward R as follows:

$$q ( s , a ) ← q ( s , a ) + {α}_{s , a} [ R - q ( s , a ) ] \qquad ( 9 )$$

In certain embodiments, selecting the action a from the set of actions [symbol] ₛ may include generating a random number μ. The random number μ may be a pure random number or a quasi-random number generated by a predetermined criterion. In the event that the random number μ is smaller than the ϵ-greedy parameter, the Wi-Fi apparatus may randomly select the action a from the set of actions [symbol] ₛ.

In the event that the random number μ is greater than the ϵ-greedy parameter, and the number of times the action a has been attempted n_{s,a} for the current environment state s is smaller than equal to the threshold μ, the Wi-Fi apparatus may select a predefined action for example, the Wi-Fi apparatus may select the OBSS PD level equal to −82 dBm and may select an index of the MCS using a specified rate adaption scheme. This step of selecting a predefined action may be applied to avoid unexpected network performance at the initial state, i.e., during the initial learning phase of the action-value function.

In the event that the random number μ is greater than the ϵ-greedy parameter, and the number of times the action has been attempted n_{s,a} for the current environment state s is greater than the threshold η, the Wi-Fi apparatus may select the action a from the set of actions [symbol] ₛ that increases the action value function q(s, a). This step of selecting the action a that increases the action value function q(s, a) may be applied when each action from the set of actions [symbol] ₛ has been tried for a given environment from the set of environment states, [symbol] for a sufficient number of times.

Once the action a is selected, the Wi-Fi apparatus may update the number n_{s,a} as:

$${n}_{s , a} = {n}_{s , a} + 1 \qquad ( 10 )$$

Also, the Wi-Fi apparatus may update the learning rate α_{s,a} as:

$${α}_{s , a} = \frac{1}{{( {n}_{s , a} + 1 )}^{{p}_{s , a}}} \qquad ( 11 )$$

Once the action a is selected, the process 500 advances to step 508, where based on the selected action a, i.e., for the selected value of index m of the MCS and the OBSS PD level l, the Wi-Fi apparatus may transmit the PDU.

In certain embodiments, the Wi-Fi apparatus may calculate a reward R corresponding to the selected action a. To calculate the reward R, the Wi-Fi apparatus may determine an acknowledgment corresponding to the transmitted PDU. When the acknowledgment is received by the Wi-Fi apparatus from a second Wi-Fi apparatus (For example, AP 212), the Wi-Fi apparatus may determine a deliver time T for delivering the PDU to the second Wi-Fi apparatus. The Wi-Fi apparatus may calculate the reward R based on a ratio of the length of the PDU and the delivery time T:

$$R = \frac{s ( 2 )}{T} \qquad ( 2 )$$

In the event that the acknowledgement is not received, the Wi-Fi apparatus may assign a zero value to the reward R.

It will be understood that, although the embodiments presented herein have been described with reference to specific features and structures, it is clear that various modifications and combinations may be made without departing from such disclosures. The specification and drawings are, accordingly, to be regarded simply as an illustration of the discussed implementations or embodiments and their principles as defined by the appended claims, and are contemplated to cover any and all modifications, variations, combinations or equivalents that fall within the scope of the present disclosure.

What is claimed is:

1. A wireless communication method comprising:
determining that a protocol data unit (PDU) is ready for a transmission by a Wi-Fi apparatus;
determining a current environment state associated with the Wi-Fi apparatus;
based on the current environment state, selecting an action from a set of actions in accordance with a reinforcement learning (RL) technique configured to select the action suitable according to the current environment state, said selecting the action includes selecting an index of modulation and coding scheme (MCS) and an overlapping basic service set (OBSS) packet detection (PD) level; and
based on the selected action, transmitting the PDU.

2. The method of claim 1 further comprising:
initializing parameters associated with the RL technique, wherein the parameters include one or more of: a learning rate, a learning rate update parameter, a discount rate, an ∈-greedy parameter, a number of times the action has been attempted for the current environment state, an action value function, and a threshold on a minimum number of times the action should be attempted for the current environment state before selecting a next action based on the current action value function.

3. The method of claim 2 further comprising:
determining that the action value function is required to be updated;
when the action value function is to be updated and the discount rate is not equal to zero, updating the action value function based on a first criterion; and
when the action value function is to be updated and the discount rate is equal to zero, updating the action value function based on a second criterion.

4. The method of claim 3, wherein the first criterion is:
retrieving a previous environment state, a previous action, and a previous reward associated with the previous action; and
updating the action value function based on the current environment state, the previous environment state, the previous action, the previous reward, and the discount rate.

5. The method of claim 3, wherein the second criterion is:
retrieving a previous environment state, a previous action, and a previous reward associated with the previous action; and
updating the action value function based on the previous environment state, the previous action, and the previous reward.

6. The method of claim 2, wherein selecting the action from the set of actions comprises:
generating a random number; and
when the random number is smaller than the ∈-greedy parameter, randomly selecting the action from the set of actions.

7. The method of claim 2, wherein selecting the action from the set of actions comprises:
generating a random number; and
when the random number is greater than the ∈-greedy parameter, and the number of times the action has been attempted for the current environment state is smaller than equal to the threshold, selecting a predefined action.

8. The method of claim 2, wherein selecting the action from the set of actions comprises:
generating a random number; and
when the random number is greater than the ∈-greedy parameter, and the number of times the action has been attempted for the current environment state is greater than the threshold, selecting the action from the set of actions that maximizes the action value function.

9. The method of claim 1 further comprising calculating a reward corresponding to the selected action.

10. The method of claim 9, wherein calculating the reward comprises:
determining that an acknowledgment corresponding to the transmitted PDU is received from a second Wi-Fi apparatus;
when the acknowledgement is received, determining a delivery duration for delivering the PDU to the second Wi-Fi apparatus, and calculating the reward based on a length of the PDU and the delivery duration; and
when the acknowledgement is not received,
assigning a zero value to the reward.

11. The method of claim 10, wherein the reward is calculated as a ratio of the length of the PDU and the delivery duration.

12. The method of claim 1, wherein the current environment state includes one or more of: an identification of a second Wi-Fi apparatus, a length of the PDU, an average received signal strength indicator (RSSI) received by the Wi-Fi apparatus from the second Wi-Fi apparatus, an average RSSI received by the Wi-Fi apparatus from an unrelated Wi-Fi apparatus, a percentage of time when a channel is occupied by transmission from other related Wi-Fi apparatuses, and a percentage of time when the channel is occupied by transmission from the other unrelated Wi-Fi apparatuses.

13. A wireless communication system comprising:
a non-transitory memory element having instructions thereon, and
at least one processor coupled to the non-transitory memory element and configured to execute the instructions to cause the wireless communication system to:
determine that a protocol data unit (PDU) is ready for a transmission by a Wi-Fi apparatus;
determine a current environment state associated with the Wi-Fi apparatus;
based on the current environment state, select an action from a set of actions in accordance with a reinforcement learning (RL) technique configured to select the action suitable according to the current environment state, said select the action includes selecting an index of modulation and coding scheme (MCS) and an overlapping basic service set (OBSS) packet detection (PD) level; and
based on the selected action, transmit the PDU.

14. The system of claim 13 further comprising initializing parameters associated with the RL technique, wherein the parameters include one or more of: a learning rate, a learning rate update parameter, a discount rate, an ∈-greedy parameter, a number of times the action has been attempted for the current environment state, an action value function, and a threshold on a minimum number of times the action should be attempted for the current environment state before selecting a next action based on the current action value function.

15. The system of claim 14, wherein the wireless communication system is further configured to:
determine that the action value function is required to be updated;
when the action value function is to be updated and the discount rate is not equal to zero, update the action value function based on a first criterion, and
when the action value function is to be updated and the discount rate is equal to zero, update the action value function based on a second criterion.

16. The system of claim 14, wherein selecting the action from the set of actions comprises:
generating a random number; and
when the random number is smaller than the ∈-greedy parameter,
randomly selecting the action from the set of actions.

17. The system of claim 14, wherein selecting the action from the set of actions comprises:
generating a random number; and
when the random number is greater than the ∈-greedy parameter, and the number of times the action has been attempted for the current environment state is smaller than or equal to the threshold, selecting a predefined action.

18. The system of claim 14, wherein selecting the action from the set of actions comprises:
generating a random number; and
when the random number is greater than the ∈-greedy parameter, and the number of times the action has been attempted for the current environment state is greater than the threshold, selecting the action from the set of actions that maximizes the action value function.

19. The system of claim 13, wherein the wireless communication system is further configured to calculate a reward corresponding to the selected action.

20. The system of claim 13, wherein the current environment state includes one or more of: an identification of a second Wi-Fi apparatus, a length of the PDU, an average received signal strength indicator (RSSI) received by the Wi-Fi apparatus from the second Wi-Fi apparatus, an average RSSI received by the Wi-Fi apparatus from an unrelated Wi-Fi apparatus, a percentage of time when a channel is occupied by transmission from other related Wi-Fi apparatuses, and a percentage of time when the channel is occupied by transmission from the other unrelated Wi-Fi apparatuses.
